(19) United States
(12) Patent Application Publication
(10) Pub. No.: US 2005/0216243 A1
(43) Pub. Date: Sep. 29, 2005

(54) Computer-simulated virtual reality environments for evaluation of neurobehavioral performance

(76) Inventors: Simon Graham, Toronto (CA); Richard Mraz, Toronto (CA); Konstantine Zakzanis, Markham (CA); Jang Han Lee, Seoul (KR)

Correspondence Address: Mark A. Litman & Associates, P.A.;Suite 205, York Business Center, 3209 West 76th St., Edina, MN, 55435, US

(21) Appl. No.: 11/069,919

(22) Filed: Mar. 1, 2005

Related U.S. Application Data
(60) Provisional application No. 60/549,257, filed on Mar. 2, 2004.

(51) Int. Cl. G06G 7/48

(52) U.S. Cl. 703/11

(57) ABSTRACT

A virtual reality (VR)-based test battery wherein various neurobehavioral performance skills, including motor skills, sensory-perceptual skills, attention, and decision-making can be measured in human subjects. The invention can be used as a screening method within a virtual environment to provide an overall measure of general brain function relating to behavioral ability. In addition, the invention provides comprehensive VR-based neurobehavioral examinations tailored to individual subjects which can automatically self-adjust during operation in accordance with the specific purpose of the assessment, or for forms of cognitive or physical rehabilitation. According to the invention, patients with neurological and psychiatric dysfunctions can be assessed with physiologic monitoring as well as with anatomical and functional neuroimaging to non-invasively map the functional neuroanatomic correlates of VR-based test performance. In a preferred embodiment, the VR-based neurobehavioral testing system is portable allowing computerized tests to be administered in a desk-top or lap-top configuration, or via the Internet for tele-assessment of human subjects who are physically inaccessible to the test administrator. In a particularly preferred embodiment, the method of the invention is used for vocational assessment and training, wherein individual test scores are combined into a final metric useful for assessing a candidate's qualifications for employment, or certification in a particular skill.

### BACKGROUND OF THE ART

1. Field of the Invention

The present invention relates generally to systems and methods for using computer simulated VR environments to evaluate neurobehavioral performance. The invention is useful in medical, psychotherapy, education, home, self-help, entertainment, and vocational training environments.

2. Background of the Art

Current methods of neurobehavioral evaluation (which is generic to neurocognitive evaluation, as it also includes cognition, emotion, memory, motor performance, perception activities, and the like) involve extensive diagnostic procedures and can be very expensive and time consuming. Typically, initial tests require the subject or patient to complete an examination with a health care professional such as a psychiatrist, clinical psychologist, or neurologist and to respond candidly to a series of personal questions and traditional measures such as batteries of questionnaires and “paper and pencil” tests. A preliminary picture of the subject's brain function is obtained by the test administrator in the form of answers to these behavioral measures. This type of evaluation is currently used to assist in diagnosis in psychiatric and neurological conditions such as schizophrenia, stroke, depression, hyperactivity, phobias, panic attacks, anxiety, eating disorders, obsessive-compulsive disorder, bipolar disorder, anxiety disorders, and other emotional disorders or conditions.

The utility of current test measures is significant and functional but needs improvement. Since most tests differ in their basic scientific assumptions, the results obtained are not standardized and often cannot be used to make meaningful case comparisons. Batteries of tests are required partly for this reason and because the measures often lack specificity for individual disorders. The efficacy of currently used methods to a large extent depends upon the cooperation of the patient and requires a large measure of self-motivation. Another problem is that dysfunctions that are readily observable during everyday activities in the real world are not necessarily easily seen in a typical test situation in the clinic. At the same time, monitoring a patient outside the clinic is often prohibitively expensive, impractical, and may take days or months to fully document.

Some attempts have been made to use computers to diagnose and educate patients about their psychological or medical condition. These evaluations often consist of questionnaires which can be filled out on a computer, or educational programs informing the patient about their condition. These methods generally are not flexible enough to meet individual patient's testing requirements.

The term “virtual reality” (VR) has generally been used to describe a computer-generated or computer-enhanced environment that can provide the user with a four-dimensional (4D; three spatial dimensions and time) interactive experience. The technology used to produce VR typically consists of a computer, a display with tracking device, a method means for activating the tracking device, and one or more input devices that provide sensory input from the virtual environment. VR applications have been developed for art, business, entertainment, flight simulators, medicine, and military battlefield operations. Applications disclosed in the prior art include computer-aided surgery, building designs for handicapped persons, wheelchair equipped with a virtual reality system, rehabilitation, repetitive strain injury, surgical workstation, and teaching aids for surgeons.

U.S. Pat. No. 5,546,943 to Gould proposes the use of a visualization system utilizing a computer to provide a patient with a view of their internal anatomy based on medical scan data. The patient acts upon the information in an interactive VR environment by using tools or other devices to diminish a visual representation of an ailment. U.S. Pat. No. 5,577,981 to Jarvik describes a VR exercise machine and computer controlled video system which produces a VR environment for exercise regimens, exercise games, competitive sports, and team sports and is also adapted to a user's individual capabilities.

Immersive, 3D, fully interactive VR technology was first introduced in 1993 by Lamson as part of a psychotherapeutic procedure (Lamson, R. 1993 “The effects of virtual reality immersion on anxiety disorders” Kaiser Foundation Research Institute; Lamson, R. 1994, “Virtual therapy of anxiety disorders: applications: VR in psychotherapy” CyberEdge Journal, Issue #20, vol. 4, No. 2. Sausalito, Calif.; Lamson, R. and Meisner, M. 1994, “The effects of virtual reality immersion in the treatment of anxiety, panic, and phobia of heights” Proceedings for Virtual Reality and Persons with Disabilities, pp. 63-68. Second Annual International Conference, Center on Disabilities, California State University, Northridge.). It is believed that these references primarily address the treatment of psychological conditions by application of a VR environment to a patient.

Exemplary of newer methods in the art for diagnosis and treatment of psychological conditions using a microprocessor-based VR simulator is U.S. Pat. No. 6,012,926 to Hodges et al, which provides a VR system for effective exposure treatment for psychiatric patients suffering from an anxiety disorder. A video screen in front of the patient displays an image of a specific virtual environment intended to trigger anxiety based on the patient's particular phobia. A head-mounted display and position sensor are worn on the patient's head. A computer program is designed to control the graphical display of the virtual environment on the video screen, monitor the position sensor data, determine the position of the patient's head, and controllably update the patient's perspective of the virtual environment on the video screen to reflect the movement and position of the patient's head. A variety of sensors are included to quantify anxiety level, and the computer program is designed to monitor the sensor and to manipulate the graphical environment displayed on the video screen.

U.S. Pat. No. 6,149,586 (Elkind) discloses using computer simulation and VR tests for determining categories of neuropsychological dysfunctions. A test subject interacts with a computer generated virtual environment according to a predetermined test script. The test script presents a virtual environment of sight and sound that can mirror a real activity or an environment. The test script is designed to present situations where subjects with executive dysfunctions will interact and make decisions which indicate the dysfunctions. During testing, other physiological measurements, including subject respiration, heart rate, blood pressure, and skin conductance changes, may be measured and recorded.

U.S. Pat. No. 6,186,145 (Brown) discloses a method and system for monitoring, diagnosing and treating psychological conditions and disorders in patients with the aid of computer-based VR simulations. A computer program includes a computer-readable medium, and a controlling mechanism that directs the computer to generate an output signal for controlling a video display device. The video display device is equipped to display representations of three-dimensional images, and the output signal represents a VR simulation directed to diagnosis and/or treatment of a psychological condition and/or disorder.

U.S. Pat. No. 6,425,764 (Lamson) discloses a method of treating a psychological, psychiatric, or medical condition by encoding electronic instructions for an interactive virtual environment that contains instructions for a scoring procedure for quantitatively analyzing the medical condition of the patient, and provides counseling instructions or self-help instructions. The virtual environment can be used in conjunction with a physical parameter measuring device connected to the VR technology unit. The process takes place during immersion in fully interactive 4D VR environments using shutter goggles, a head-mounted-display, or other form of visual stimulation, and may include the use of voice, music, and sound and other forms of physiological stimulation and feedback. Body sensors and devices such as a hand-held grip permit the user to interact with objects and navigate within the virtual environment.

U.S. Pat. No. 6,503,085 (Elkind) provides computer simulation and VR tests for determining categories of neuropsychological dysfunctions. A test subject interacts with a computer generated virtual environment according to a predetermined test script. The test script presents a virtual environment of sight and sound that can mirror a real activity or an environment. The test script is designed to present situations where subjects with executive dysfunctions will interact and make decisions which indicate dysfunctions. During the testing, physiological measurements may be measured and recorded.

U.S. Pat. No. 6,162,189 (Girone et al.) provides for an ankle rehabilitation system utilizing a mobile platform that can be moved in six degrees of freedom (6 D-O-F). The measured position and force are forwarded to an electronic interface and fed to a programmable computer, which determines desired force feedback to be applied by the controller interface to the mobile platform. The rehabilitation system can include simulation of virtual objects which can be moved by the user to provide exercise in a computer game-like format. The system also can be remotely controlled in a telerehabilitation configuration, in which the rehabilitation therapist is remotely directing and monitoring the course of therapy on an additional computer connected to the system over the internet.

U.S. Patent Application Ser. 20020146672 (Burdea) discloses a method and apparatus for rehabilitation of neuromotor disorders utilizing various parameters of hand movement in a virtual environment that also provides performance-based interaction with the user to increase user motivation while exercising. A data glove device senses position of digits of the hand of the user while the user is performing an exercise by interacting with their virtual hand in a variety of simple virtual environments. Another device provides force feedback to the user and measures position of the digits of the hand while the user is performing an exercise with their virtual hand in a virtual environment. The virtual environment is updated based on targets determined for the user's performance in order to provide harder or easier exercises.

U.S. Pat. No. 6,563,107 (Danish et al.) describes a measuring device for providing data corresponding to a geometric configuration in space, the device being in the form of a flexible, compliant, measurement member capable of bending in at least one degree of freedom, the member extending along a medial axis or plane and having spaced flexure sensors distributed at sensing locales having known locations on the member and separated by known sensor spacing intervals to provide flexure signals indicating the local state of flexure present at the locations. This type of system can be used to develop virtual reality information to use in the systems of the present invention.

The patented inventions referenced above provide useful measures for the diagnosis and treatment of psychological conditions using microprocessor-based VR simulation. However, each invention also has significant inherent limitations. In each case, the invention is insufficiently comprehensive to enable broad assessment and rehabilitation capabilities in VR. The ideal system should provide a comprehensive series of VR-based tests which can be used to index general cognitive functioning, as well as individualized VR paradigms for specific cognitive rehabilitative strategies. The prior art inventions disclose the use of virtual environments that integrate learning principles and psychotherapeutic strategies that utilize visual, auditory, and tactile sensory stimulation and feedback during user immersion in virtual environments that can be controlled by the clinician or therapist. However, none consider that the assessment or rehabilitation procedure can be assisted or in fact controlled by the computer itself, to elucidate patient behavior or to assist patients in achieving corrective experiences. In addition, no inventions to date make use of the brain activity associated with exposure to VR to influence the assessment or rehabilitation procedure.

### SUMMARY OF THE INVENTION

A method performs a virtual reality-based test wherein neurobehavioral performance skills are measured in human subjects. In the method, a system
(a) provides interactive virtual reality-based neurobehavioral tests, wherein a plurality of virtual environments are available to evaluate said neurobehavioral performance skills,
(b) provides an input technology for receiving feedback responses to said interactive virtual reality environment from said human subjects, the neurobehavioral tests at least having the capability of automatically self-adjusting (and possibly an administrator adjusting) during operation in accordance with at least one specific purpose of the assessment or rehabilitation,
(c) provides an advanced computer workstation which displays said virtual environments to users through various output devices, and
(d) records performance metrics reflecting said neurobehavioral skills of said human subjects.

The apparatus used would include at least a virtual reality display and interactive system and communication connection with a processor that can analyze data and fit data into matrices indicative of diagnoses.

The present invention provides several advantages over the prior art by incorporating a functional and anatomical neuroimaging component that adds specificity in terms of evaluating brain-behavior relationships when making a clinical diagnosis, and that assists in the selection of the appropriate rehabilitation strategy for specific patients. Functional neuroimaging is defined as the spatio-temporal data obtained by various imaging methods that are sensitive, directly or indirectly, to the activity of neurons within the brain, or neurometabolic factors such as cerebral perfusion or cerebral rate of oxygen consumption. Functional neuroimaging methods which could be used to practice the invention include, but are not limited to electroencephalography, magnetoencephalography, single photon emission computed tomography, positron emission tomography and functional magnetic resonance imaging (fMRI). Functional MRI has numerous advantages, such as cost, availability, risk and invasiveness, sensitivity, spatial and temporal resolution, and volume of coverage within the brain. Technical challenges for fMRI include the need to operate VR equipment at high magnetic fields with minimal electromagnetic interference with fMRI signals, the sensitivity of fMRI to head motion, and the need to design specific behavioral tasks and analytic approaches to ensure fMRI data of high quality. Notwithstanding these problems, the technology required to perform the VR-fMRI experiments disclosed by the present invention is now available.

While less studied at present, the invention can be used to diagnose and treat the following other diseases which have now been found to frequently involve vasospasms: neurobehavioral disorders such as, dyslexia, memory disturbances, depression, psychosis, reflex sympathetic dystrophy, mood disorders and sensory motor disorders; transient ischemic attack (TIA), pseudoseizure, hemibalism, and stroke; tremor, Parkinson's disease, torticollis, electrical shock trauma, as well as any other disease in which vasospasm can be detected as a component of symptoms. Even cases of Benign Prostate Hypertrophy (BPH) can be treated with the vasodilators of the invention to relax the smooth muscle of the sphincter (where the vasodilator relaxes the muscle even where vasospasm is not a symptom) allowing better emptying of the bladder. Further clinical testing has also established the usefulness in some cases, of additional diseases which have now been found unexpectedly to involve a substantial degree of vasospasm, comprising; vertigo, autism, depression, psychosis, transient global amnesia, memory disabilities, balance disabilities, Tourette's Syndrome, Tinnitis, Multiple Sclerosis and Multiple Sclerosis-like syndrome, hyperactivity and Attention Deficit Disorder, deficits resulting from strokes of various causes, migraine, seizures, balance disorders, concussion, post-concussion syndrome sometimes including temporal mandible joint pain (TMJ) or facial pain, cerebral ischemia and other vascular components discovered to be associated symptoms in some cases of psychiatric disorders such as chronic depression and some psychosis, as well as vascular dysfunction from any cause such as kidney disease and peripheral vascular disease e.g. from diabetes, cholesterol, infection or other cause. A basic factor is that many neurological diseases can be approached as symptom diagnoses for the most part. Thus depression is the diagnosis for a specific type of behavioral abnormality, not the underlying pathological or anatomical diagnosis. This is also true for stroke, multiple sclerosis, vertigo, balance disorders, and many other diseases may be directly caused by ischemia, or have a component of their problem caused by ischemia, or have associated problems caused by vasospasm arising from their associated problems.

The present invention also creates individualized virtual measures for specific vocational and educational needs which may predict future employment/success in the workplace or school. According to the method of the invention, these virtual measures can be provided over the internet so that brain function can be assessed or rehabilitated in persons in remote areas or within associated health-care centers in an urban area.

It is one aspect of the present invention to provide a method and apparatus for diagnosis and treatment of neurobehavioral conditions in human subjects and patients using a computer-based VR-based neurobehavioral test battery.

A second aspect of this invention is to provide a VR-based neurobehavioral screening measure, wherein one or more neurobehavioral abilities can be measured within a single virtual environment.

A further aspect of the invention is to provide a VR-based neurobehavioral examination tailored to the needs of the individual patient or client and the purpose of the assessment.

Yet another aspect of the invention is to provide a VR neurobehavioral test battery that can self-adjust during operation to increase or decrease the difficulty of the test protocol, according to the performance of the patient or client, or according to a normative database.

It is another aspect of the present invention to provide physiological and metabolic correlates as well as anatomical and functional neuroimaging correlates to the VR neurobehavioral test battery to improve the specificity of a clinical diagnosis or rehabilitation strategy.

Still another aspect of the invention is to provide a series of assessment measures derived from the virtual environment which can be used to index cognitive functioning in general.

Another aspect of the present invention is to provide a series of assessment measures derived from the virtual environment to assess a specific cognitive domain, such as, for example, prospective memory or visual long term memory.

A further aspect of this invention is to provide individualized assessment measures derived from the virtual environment for specific cognitive rehabilitative strategies.

Yet another aspect of the present invention is to provide individualized assessment measures derived from the virtual environment for specific vocational and educational needs, which will predict future employment/success in the workplace or school.

A further aspect of the invention is to provide a computer-based VR-based neurobehavioral test battery or rehabilitation system that can be administered over the internet to subjects in remote locations.

Another aspect of the invention is to provide a computer-based VR-based neurobehavioral test battery or rehabilitation system that can be administered over the internet to subjects in between interconnected health-care centers in urban areas.

Additional objects, features, and advantages of the present invention will become evident from the following detailed description and referenced drawings.

### BRIEF DESCRIPTION OF THE DRAWINGS

FIG. 1 is a conceptual diagram illustrating the general operational modes of the VR-based neurobehavioral test system disclosed in the present invention.

FIG. 2 is a flowchart illustrating the top-level operational architecture of the present invention.

FIG. 3 illustrates a preferred embodiment of the invention that is particularly useful for patient assessment and rehabilitation.

FIG. 4 illustrates the functional integration of the VR-based test system with the test administrator's computer, with an intranet at the administrator's site, and with an independent web server. This embodiment of the invention is particularly useful for teleassessment and telerehabilitation.

FIG. 5 illustrates an embodiment of the invention that is useful for evaluating the functional neuroanatomic correlates of the subjects behavior in the virtual environment, via functional magnetic resonance imaging (fMRI) to enhance the specificity of the VR-based assessment measures.

FIG. 6 illustrates the method-of-use and application of the VR-based neurobehavioral test battery for vocational assessment.

FIG. 7 is a flow chart illustrating the application of the “Office Courier Task” embodiment of the present invention for evaluating one aspect of executive functioning and one aspect of vocational assessment.

FIG. 8 illustrates the application of the “Conveyor Task” embodiment of the present invention for evaluating and treating attention deficits and disorders, and for vocational assessment.

FIG. 9 shows a flow chart of variations of the conveyor or assembly line task of FIG. 8.

### DETAILED DESCRIPTION OF THE INVENTION

The present invention provides methods and an apparatus for diagnosis and treatment of neurobehavioral conditions in human subjects and patients using a computer-based VR-based neurobehavioral test battery, wherein a number of virtual environments are provided and various neurobehavioral abilities can be measured. Examples of neurobehavioral abilities which can be evaluated by the present invention include a) motor skills, b) manual dexterity, c) praxis, d) sensory-perceptual skills, e) sustained, divided and selective attention, f) executive functioning, including planning, decision making, conceptual flexibility, multi-tasking, spontaneity, memory and its variant processes including working memory, encoding and retrieval, recognition, visual, prospective, spatial, source, contextual, remote, autobiographical, procedural, implicit, and semantic memory, g) expressive and receptive language, h) visual spatial ability, i) visual constructional, j) visual tracking, k) visual motor, l) mood and personality (e.g., which can be presented in one or more sequences of scenarios that elicit specific effects/reactions, particularly for the individual participant, such as scenes of the terrorist attack on the World Trade Center, Vietnam scenario, a doctor delivery a diagnosis of terminal cancer, combined with a recording system for eye-tracking, video capture of facial expressions, skin conductance recording, fMRI, and the like), m) intelligence, and n) pre-morbid ability. The apparatus of the present invention includes a suite of physiological monitoring tools, including monitors for heart rate, respiratory rhythms, eye tracking, video capture of facial expression or limb kinematics, electromyography, and skin conductance response, which can be used in conjunction with the functional neuroimaging and normative data included in the system of the invention.

The method of the present invention can be used as a screening measure, wherein one or more neurobehavioral abilities can be measured within a sole virtual environment, thereby providing an overall measure of general neurobehavioral ability, with specific ability performances parceled into subtest scores. In addition, the method of the invention can be used to select, administer and interpret test results from one or more specific virtual environments to yield a comprehensive measure of a subject's strengths and weaknesses. According to the invention, each VR-based neurobehavioral examination can be tailored to the needs of the individual client and the purpose of the assessment. Additionally, the controller/administrator or the program itself can shift among environments in response to results obtained in previous environments, focusing information gathering in a sequence of events where the sequence is determined from results in a previous VR environment. Each sequence can be tailored for evaluation of specific disorders based upon indications from previous results.

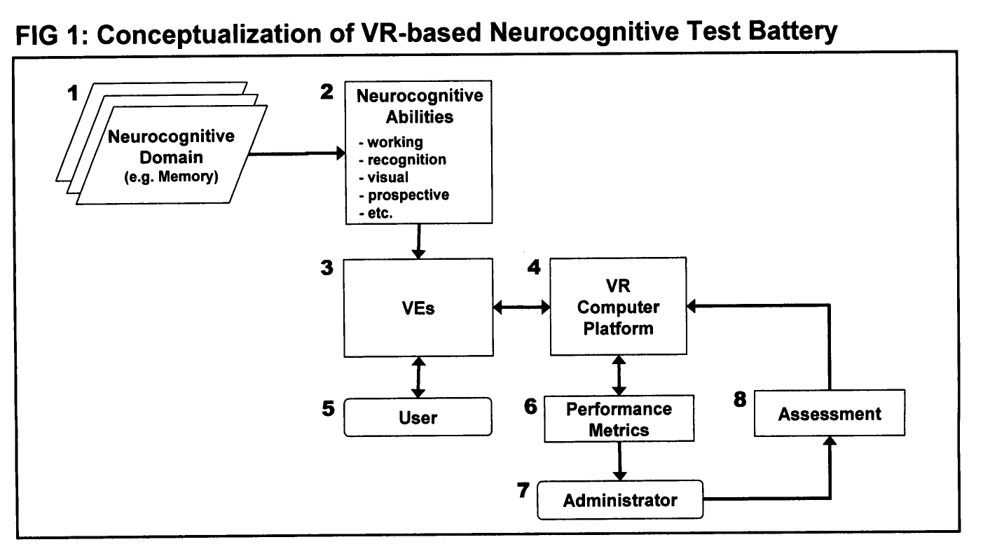

FIG. 1 illustrates a conceptual operational architecture of a VR-based neurobehavioral test system disclosed in the present invention. From a set of neurobehavioral domains, a specific neurobehavioral domain 1 is divided into distinct neurobehavioral abilities 2. Ecologically valid tasks are developed to assess measureable neurobehavioral abilities in a specific operational context of one or more virtual environments 3. An advanced VR computer platform 4 displays the interactive virtual environments to the user 5. The user interacts with the virtual environment 3 in a manner that is recorded by VR computer platform 4. Performance metrics 6 are derived from these records. These metrics either enable the administrator 7 to assess neurobehavioral ability 8, or, for specially-developed software on the VR computer platform 4, make an independent assessment. In both cases, this assessment can be fed back through VR computer platform 4 to adjust the virtual environment 3 for therapeutic or other evaluative purposes. For example, when test results have strongly tended towards a particular diagnosis, subsequent tests (and subsequent VR environments) can be more specific to confirmation or refutation of that diagnosis. A loop can be built into the program where when specific tests indicate strong possibilities for one or multiple diagnoses, VR neurobehavioral tests may emphasize specific testing modes for a single condition at one time (by moving along a specific fork in a digressing test pattern), and after confirmation or refutation of that condition by the program, the software will return to the fork and move down another path to confirm one condition over another or confirm another condition or maintain possibilities for diverse diagnoses.

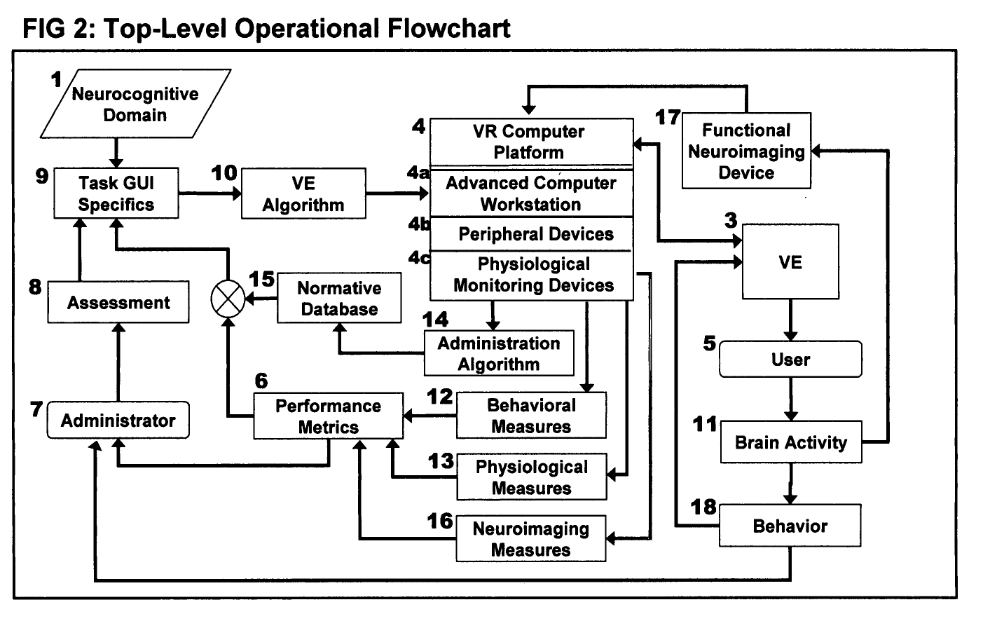

With reference to FIG. 2, a top-level operational flowchart is illustrated that describes in more detail subcomponents that may be practiced in the present invention and how they are flexibly inter-related to enable different embodiments. A specific neurobehavioral domain 1 is first divided into a series of ecologically valid task specifics represented on a graphical user interface 9 that operationally defines task parameters within a specially designed virtual environment algorithm 10. The algorithm 10 runs on VR computer platform 4 that contains an advanced computer workstation 4a, VR peripheral devices 4b (such as a head mounted display (HMD), tracking system, data glove, joystick, scan converter, video cassette recorder, and television monitor), and physiological monitoring devices 4c that can be used to reflect the status of the patient via sensors on/in the body (such as probes or apparatus which monitor tissue oxygen levels, blood flow, or skin conductance response). The user interacts with the virtual environment 3 generated by the VR computer platform through specific behavior 11. That behavior is also recorded by the VR computer platform peripheral devices 4b and physiological monitoring devices 4c. Through a variety of behavioral measures 12 (such as rating scales based on the administrator's characterization of the user's behavior in the virtual environment, either in real-time or retrospectively by video recording) and physiological measures 13 that are collectively reduced to a series of performance metrics 6 sensitive to neurobehavioral function. According to the invention, these metrics together with subjective evaluation of the user's behavior subsequently enable the administrator 7 to make an assessment 8 of neurobehavioral function. Optionally, the assessment can be used to modify virtual environment task specifics 9 for rehabilitation or other evaluative purposes.

Another feature of the invention can provide awareness of subject performance, whereby the VR neurobehavioral test battery can self-adjust itself during operation, increasing or decreasing the difficulty of the task during execution, or shifting VR environments in response to identified diagnostic paths. In a preferred embodiment, a feedback mechanism can be used to automate and optimize the VR test battery, wherein a number of physiological variables can be taken into account by an administration algorithm 14 to modify the input/output characteristics of the VR-based test system. According to the invention, the administration algorithm 14 evaluates performance metrics 6 in relation to a normative database 15 containing statistical distributions of performance metrics for a population of normal individuals and populations of patients with specific neurobehavioral impairments. On the basis of these data, the VR computer platform can estimate neurobehavioral status and use this information to change the task specifics 9. In one embodiment, the administration algorithm preferably utilizes proportional-integral-derivative control functions, adaptive control functions, nonlinear control functions, multi-variable/state-space control functions, stochastic control functions and/or any other functional approach deemed appropriate for the implementation of the test metrics. In one preferred embodiment of the method of the invention, the controller can be designed to respond to changes in the patient's condition using neural network artificial intelligence or other cybernetic techniques that allow the feedback mechanism to “learn” the best way to respond to changes in the patient's neurobehavioral, physiologic, or metabolic status. Such techniques might employ, among other techniques, “fuzzy logic”, or multivariate “Partial Least Squares” algorithms that can function in the presence of incomplete or indeterminate data.

One example of an algorithm in IN/OUT/NEUTRAL format would be based upon the range of measured results of four test parameters (T1, T2, T3 and T4) in a first VR environment (VR1), with three additional VR test environments (VR2, VR3 and VR4) available, and with a matrix of test data developed for TWENTY neurobehavioral conditions (e.g., NC_{1 . . . 20}) and data evaluation procedures. For example, simple algorithmic instructions would be based upon data (d) of the first battery of test results (T1, T2, T3 and T4) as follows:
dT1 IN/OUT/NEUTRAL f(NC_{1 . . . 20})?
   YES for f(NC_{1-5, 8, 12-15, 18-20}) NO for f(NC_{6, 7, 9-11, 16-17})
dT2 IN/OUT/NEUTRAL f(NC_{1 . . . 20})?
   YES for f(NC_{1-3, 7, 8, 11-14, 19-20}) NO for f(NC_{4-6; 9-10, 16-17}) NEUTRAL for f(NC_{15; 18})
dT3 IN/OUT/NEUTRAL f(NC_{1 . . . 20})?
   YES for f(NC_{2-3, 8, 12-13, 19-20}) NO for f(NC_{1, 4-7; 9-11, 14-17}) NEUTRAL for f(NC₁₈)
dT4 IN/OUT/NEUTRAL f(NC_{1 . . . 20})?
   YES for f(NC_{7, 8, 13-14, 20}) NO for f(NC_{1-6; 9-12, 16-19}) NEUTRAL for f(NC₁₅)
Determine all YES/NEUTRAL
   8, 13, 18
PERFORM VR2 for 8, 13, 18.

In another embodiment, behavioral metrics 12 and physiological metrics 13 are supplemented by neuroimaging measures 16, which are obtained by conducting the VR neurobehavioral test battery within a functional neuroimaging device 17 to measure the user's brain activity 18 in relation to the specific behavior 11 elicited within the VE 3. These data are then additionally reduced within the performance metrics 6 for use either by the administrator 7 or the administration algorithm 14. To facilitate control by the administration algorithm 14, normative database 15 can additionally be supplemented with the analogous neuroimaging performance metrics for normal subjects and patient populations with neurological and/or psychiatric disorders.

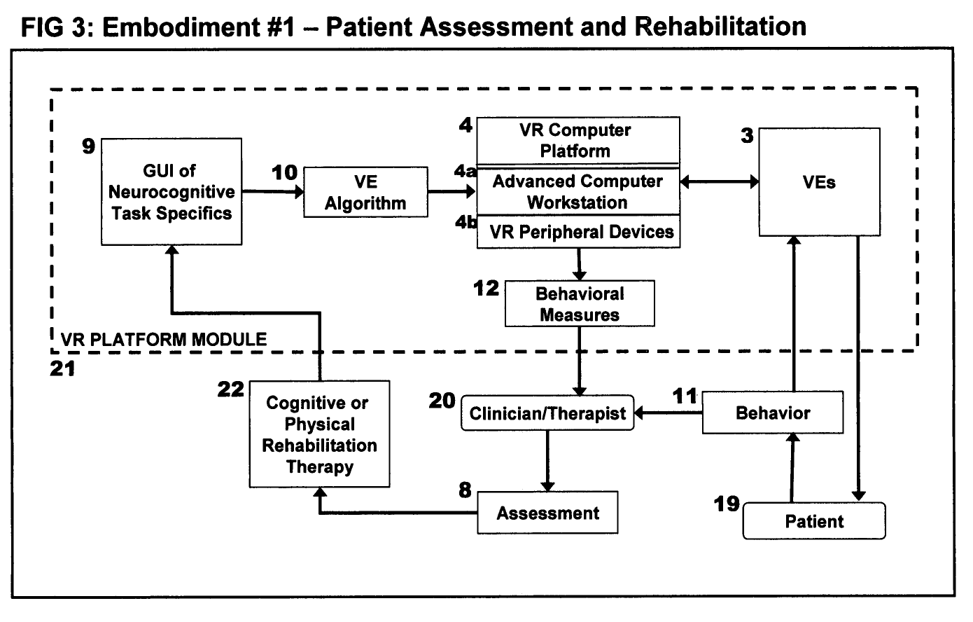

FIG. 3 illustrates a simple application of the invention for patient assessment and rehabilitation. In this embodiment of the invention, various neurobehavioral tests are implemented based on the task specifics GUI 9 using VE algorithm 10 implemented by VR computer platform 4 within a series of virtual environments 3. The behavior 11 of the patient 19 is evaluated directly and subjectively based on the experience of the clinician/therapist 20, as well as on the basis of behavioral measures 12 obtained solely from VR peripheral devices 4b. Components 3, 4, 9, 10, and 12 constitute the most basic “VR Platform Module” 21, which more generally consists of the hardware, software, and data analysis components of the invention. The clinician/therapist 20 subsequently makes an assessment 8 of neurobehavioral status. According to the invention, the complexity of various tasks/environments can then be increased or decreased in real-time by the clinician/therapist 20 via the task specifics GUI 9 for the purposes of refining the assessment 8, conducting testing on another virtual environment, or administering the task as a form of cognitive or physical rehabilitation therapy 22.

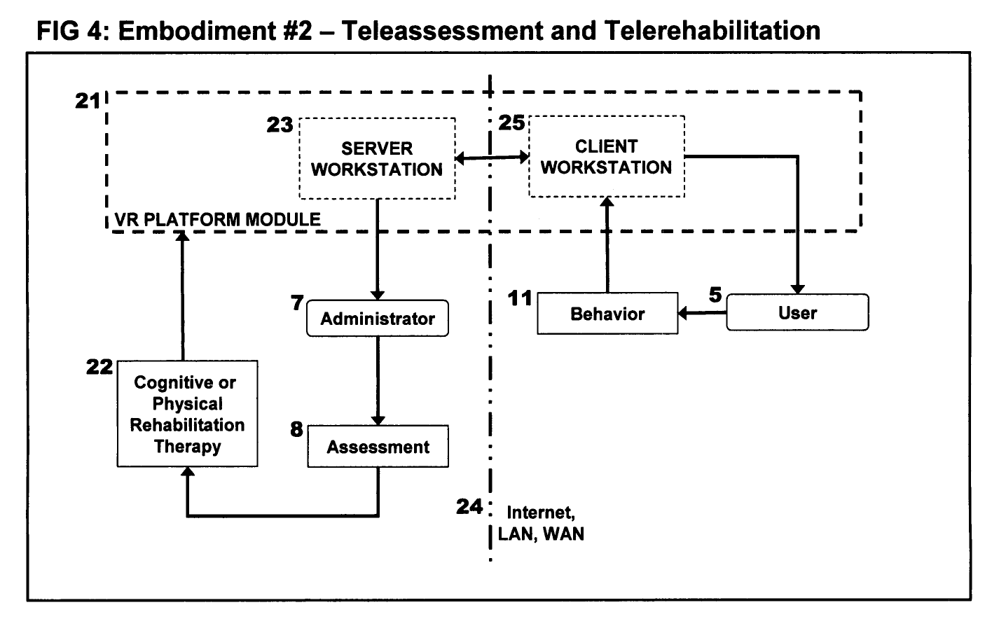

An exemplary embodiment of the present invention is its portability feature, which provides for computerized tests to be administered in a desk-top or lap-top configuration. The method of the invention also provides the ability to package and execute tests over the Internet and allows for remote assessment and rehabilitation opportunities for subjects physically inaccessible to the administrator. The invention thus has significant practical utility for telemedicine, teleassessment and telerehabilitation. FIG. 4 illustrates the functional integration of the VR-based test system with an independent web server 23 through the internet, or local area network (LAN) or wide area network (WAN) 24, for collection and analysis of diagnostic data originating with subjects in remote locations. The VR platform module thus potentially extends over a large physical distance and terminates as a client workstation 25 providing VR to the user. Neurobehavioral tests can be delivered and executed on the client side (desktop or laptop configuration), or administered in real time via the server workstation 23. User behavior 11 and physiological data can be immediately relayed over to the server 23 for assessment purposes or to vary the difficulty of the current task. Users of the system can be located in remote locations otherwise inaccessible to the administrator 7. According to the invention, test administrators can be located on either end of the system but are always able to communicate with end-users through voice or text. In some situations, for example, rehabilitation test paradigms, users are able to perform the tests without direct administrator involvement, under computer control. In the latter situation, a local caregiver, family member or friend optionally can be available for assistance.

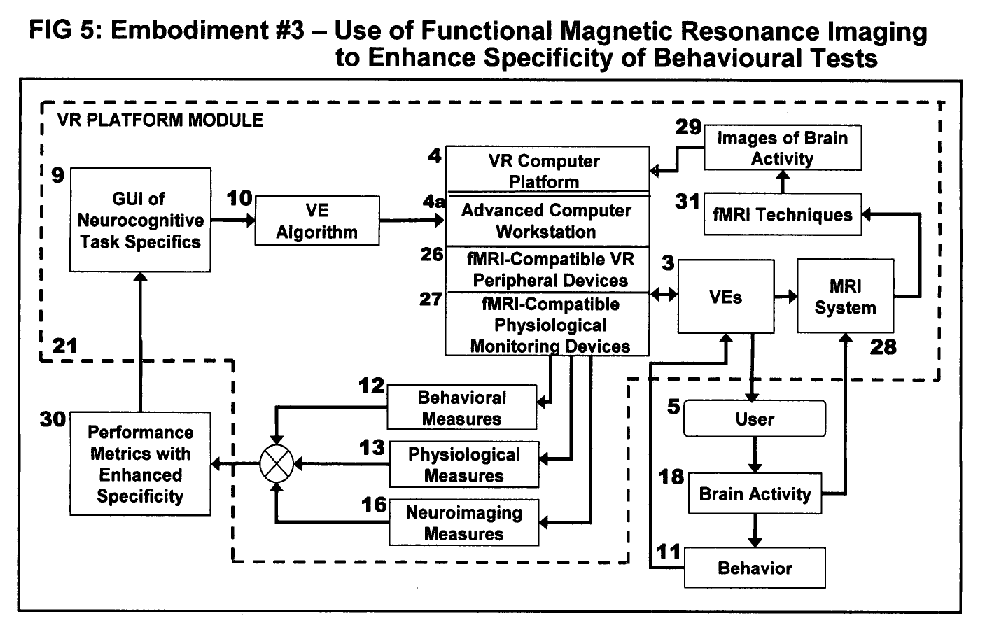

FIG. 5 provides a schematic depiction of how a VR platform module 21 can be used to deliver an integrated series of VR-based neurobehavioral tests that are executed in conjunction with a functional neuroimaging device 17 to measure the brain activity of the user 5 associated with their behavior within the virtual environment 3. In a particularly preferred embodiment of the invention, a suite of fMRI-compatible VR peripheral devices 27, including fiber-optic data gloves, display systems and writing devices, as well as joysticks, keyboards and force feedback devices, all of which have been designed for operation at high magnetic field and with negligible electromagnetic interference with MRI signals, can be employed to enable the virtual environment 3 to be delivered to the user 5 while they are located inside a magnetic resonance imaging (MRI) system 28. Functional MRI-compatible physiological monitoring equipment 28, analogous to that described with respect to FIG. 2, further characterizes performance of the user 5. Functional MRI techniques 31 can be used to provide images of brain activity 29 while the user 5 performs various aspects of the test, all within the selected virtual environment 3.

According to the invention, combining behavioral measures 12 and physiological measures 13 with neuroimaging measures 17 (such as the strength or extent of brain activation signals in specific brain regions, as observed using fMRI) enables calculation of performance metrics with enhanced specificity 30 for assessing neurobehavioral status. This embodiment is of importance for improved clinical assessment of patient populations, and for enhancing the normative database that is required for clinicians or the VR computer platform module 22 itself to perform VR-based behavioral assessment or therapeutic procedures on patient populations in which neuroimaging cannot be performed for practical reasons (such as cost, or lack of availability).

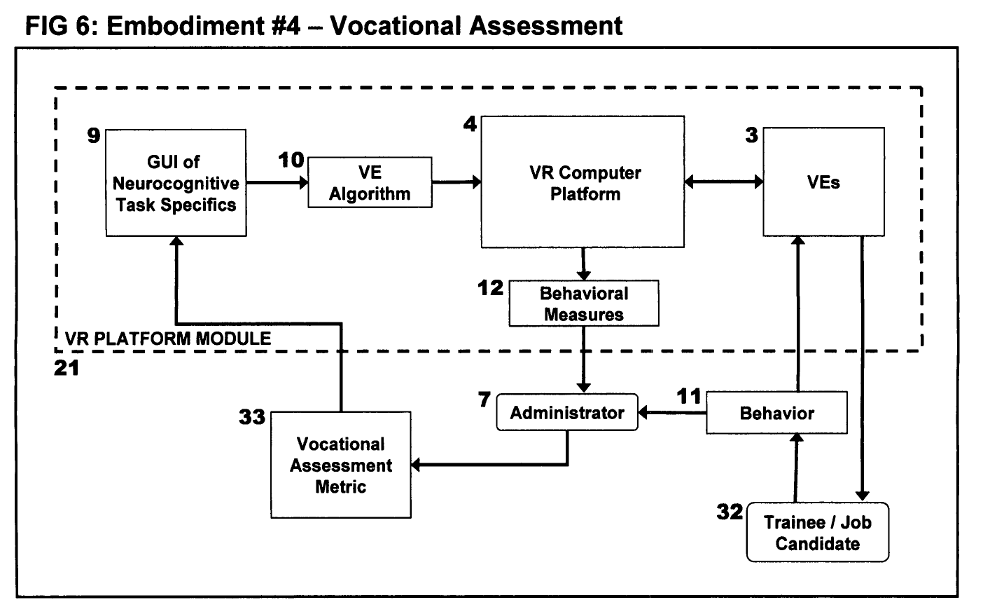

In a particularly preferred embodiment, the present invention is used for vocational assessment and training, as shown in FIG. 6. In this non-limiting example, performance of the trainee/job candidate 32 is assessed for a realistic virtual environment representing the job of interest and/or the skills required to perform the job, such as simple assembly line or secretarial-type tasks, or a more complex city environment to simulate and test driving ability. Task performance behavior 11 is subjectively evaluated by the administrator 7, or the results of individual test scores (as characterized by behavioral measures 12) can be combined into a final vocational assessment metric 33. The metric quantifies, for example, a recommendation to hire a job applicant, or to measure objectively a candidate's suitability for employment, or to determine the extent to which new skills are being learned. According to the invention, this embodiment could also be performed using a teleassessment arrangement, whereby an administrator 7 could screen candidates in remote locations. Further in the method of the invention, this embodiment could be implemented in a training mode in which the administrator 7 or the VR computer platform 4 feed back their assessment to modify task parameters within the virtual environment, in an attempt to make the user learn and improve their performance.

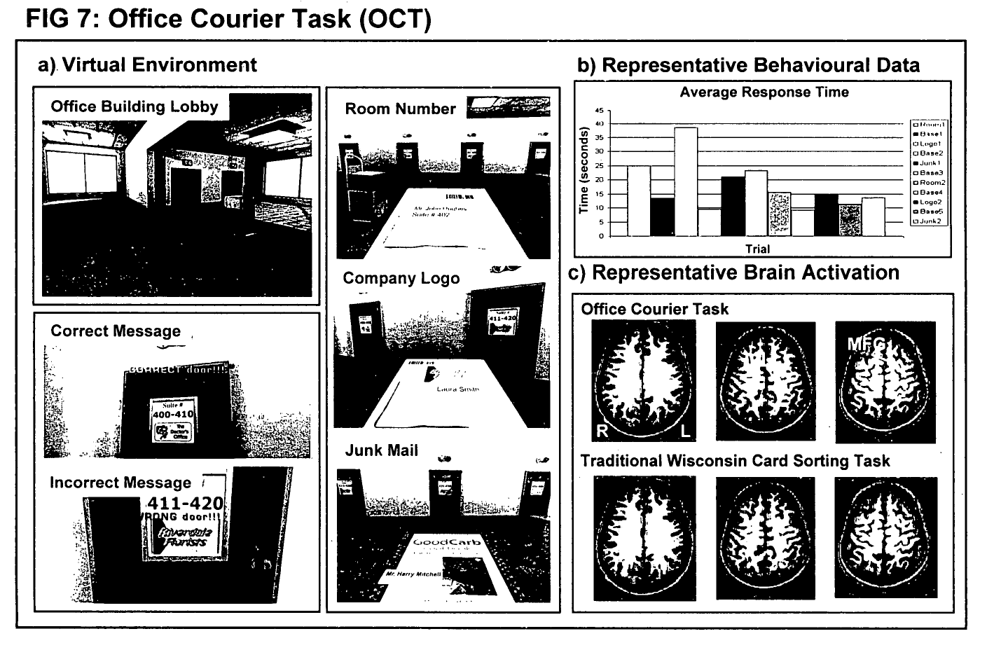

The method of the invention will now be further described by way of a detailed example with particular reference to certain non-limiting embodiments and to the accompanying drawing in FIG. 7.

### EXAMPLE 1

### Office Courier Task

A method and system of the present invention can be used to fundamental advantage to create ecologically valid, ‘pure’ tests of mental flexibility. In psychological literature, an ecologically valid test is understood to elicit behavior that generalizes well to that associated with the activities of daily life. Traditional neuropsychological tests of executive functions, such as mental flexibility, often lack ecological validity and specificity with respect to testing cognitive function. Measurements of performance related to these tasks are often confounded by the involvement of multiple cognitive processes. For instance, the Wisconsin Card Sorting Test (WCST) has long been a widely-used test of frontal lobe function. In this test, the test subject is shown four cards placed on a table. The cards show pictures of symbols of different shape, color, and number. There are four different possibilities for number (1,2,3,4), color (red, green, blue, yellow), and shape (circle, cross, star, and triangle). The test subject is given an additional card, and must determine the rule for matching the additional card to one of the four cards (either by number, color, or shape), by trial and error. After a number of attempts at matching, the administrator changes the matching rule and the testing continues. On completion of the test, a scoring scheme is used to calculate how quickly the patient learns the matching rules and how easily the test subject switches from one rule to the other. It is evident that this test is “contrived”, as it is difficult to predict how performance on the WCST translates to performance of daily activities. This may also be a problem from the standpoint of the patient, who may find such a contrived test rather uninteresting or engaging, and as a result may score significantly worse than their actual cognitive ability. Further complicating these issues, the WCST is not “pure” and tests a variety of neuropsychological processes in addition to mental flexibility, including working memory and perseverance tendencies, that are interdependent within the task in a manner that is unlikely to be ecologically valid. This limits the specificity with which particular behaviors or dimensions of cognitive functions can be evaluated. The ecologically-valid Office Courier Task (OCT) was designed to overcome the shortcomings of the WCST and other tests of mental flexibility, and to be highly interesting and interactive, motivating the patient to perform to their true level of cognitive ability. In addition, the OCT serves the additional purpose of specific vocational testing.

With reference to FIG. 7, the virtual environment used for the OCT mimics an office building lobby containing four offices/businesses, a doctor's office, flower shop, photography store, and catering company, as well as a set of elevators. In one example of a method of the invention, the test subject is required to take on the role of a courier employee and deliver mail (in the form of parcels, envelopes, magazines, etc.) to the various offices or businesses found on the floor. As determined by the nature of the objects that the subject picks up, the test subject is required to first match mail according to room number, then according to company logo, and finally according to appropriate junk mail category using a paradigm similar to the WCST. The participant is informed whether they are correct or incorrect at each trial through a text prompt that appears on the display when they make a delivery, after which they must pick up the next piece of mail. However, unlike the WCST, the OCT is ecologically valid, requiring the subject to deliver mail as opposed to sorting cards. Second, although all three sorting strategies (i.e., color, form, and number) are possible on every trial of the WCST, by the nature of the mail, the Office Courier Task imposes a single possible correct outcome on each trial. With only one correct sorting strategy for each piece of mail to be delivered, test subjects do not have to keep the current sorting category in working memory. Therefore, this task is much less taxing on working memory processes. This design also affords less possibility for perseveration. Participants cannot perseverate on a previous category because each package can only be sorted on one dimension (although they can still perseverate by continuously sorting to the wrong category). This task thus focuses primarily on the participant's ability to shift set or to be cognitively flexible. Therefore, in addition to providing the advantages of a more ecologically valid test, this embodiment of the invention offers a more ‘pure’ or specific test of mental flexibility.

In addition to the fact that the three sorting strategies mentioned above are relatively unambiguous, potentially simplifying the task in relation to the WCST, the fourth category provides a separate level of difficulty. The participants must determine whether junk mail is delivered to the specific offices that match the content of the junk mail, or to the Doctor's office. In real life, a Doctor's office would likely contain a waiting room, which would be a logical place to deliver junk mail. The participant must determine which is the correct rule (office that matches subject matter, or Doctor's office) again by trial and error.

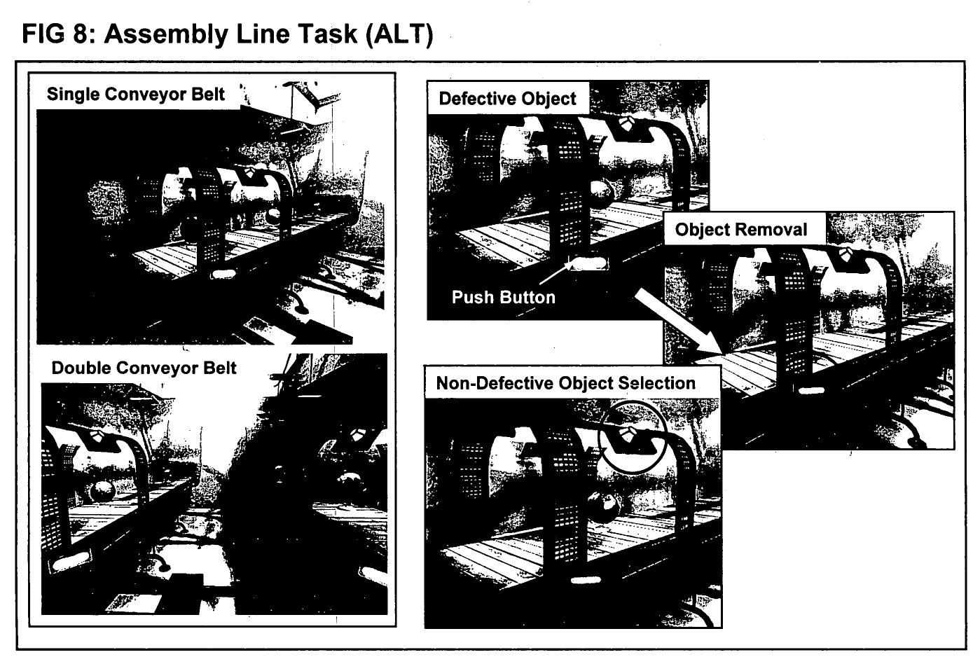

The method of the invention will also described by way of a second detailed example with particular reference to certain non-limiting embodiments and to the accompanying drawing in FIG. 8.

### EXAMPLE 2

### Assembly Line Task

The Assembly Line Task (ALT) was designed for attention assessment and training purposes in individuals with attention deficits and disorders, such as those that occur following traumatic brain injury. In the method of the invention, the conveyor belt(s) is (are) the focus of a series of tasks of increasing complexity requiring divided and sustained attention. According to the invention, the goal of the ALT is to improve a subject's attention span under low arousal conditions, in terms of reduced length of time for completion of increasingly complex tasks. The level of difficulty of the series of tasks can be easily tailored to the needs of each patient, thus maximizing their effectiveness. The concreteness of the tasks also makes the attentional gains realized in the test more readily generalizable to real-world activities. As an assessment tool, performance on different difficulty levels of the ALT can be used in comparison with a normative database including healthy performance as a function of age, and impaired performance as a function of neurological or psychiatric disorder, for the purpose of assisting in patient diagnosis.

With reference to FIG. 8, the ALT environment mimics a typical factory setting with two conveyor belts and an operator's platform. Various objects travel down the belts in different directions and speeds; all dependent on the type of task and the current level of difficulty. The operator's platform contains 2 buttons to remove objects from one other the other selected belt.

Participants are asked to remove certain type of objects (e.g. defective toys, machine parts, etc.) from a conveyor belt while ignoring those that are not defective or not required for the task. In the method of the invention, the difficulty of the task can be increased by having the participant focus on both belts or by asking them to remove more than one object type at a time. According to the invention, the belt speed, direction, or object presentation order can all be easily modified to increase or decrease the difficulty. An auditory stimulus can be added to the task to serve as an additional attentional demand (i.e. press a button whenever a tone is heard) or to cue the participant when the desired object has reached the operator's platform.

Given the flexibility with which this virtual environment can be adapted to assess specific attentional processes and for rehabilitation, a series of specific behavioural tasks are outlined below for sustained attention, alternating attention, selective attention, and divided attention. Tasks are provided in at least two and preferably at least three levels of difficulty, for the assessment of patients with different levels of impaired attention and so that the difficulty can be increased for rehabilitation purposes.

Sustained Attention

1st level: One type of object (e.g., red and blue globes) is presented at a rate of one object every 2 seconds (time spent in the highlighted box). The participant must select globes that are defective in color (e.g. red). The participant must do this for 3 minutes.

2^{nd} level: One type of object (e.g., red and blue globes) is presented at a rate of one object every 2 seconds (time spent in the highlighted box). The participant must select globes that are defective in color (e.g. red). The participant must do this for 5 minutes.

3^{rd} level: One type of object (e.g., red and blue globes) is presented at a rate of one object every 2 seconds (time spent in the highlighted box). The participant must select globes that are defective in color (e.g. red). The participant must do this for 10 minutes.

Alternating Attention

1st level: Two types of object (e.g., globes, miniature cars) are presented at a rate of one object every 2 seconds (time spent in the highlighted box). The participant must select only globes, then the rule is reversed so that the participant must pick up only cars. The rule switch occurs every 3 minutes over a 9 minute interval.

2^{nd} level: Two types of object (e.g., globes, miniature cars) are presented at a rate of one object every 2 seconds (time spent in the highlighted box). The participant must select only globes, then the rule is reversed so that the participant must pick up only cars. The rule switch occurs every 2 minutes over a 6 minute interval.

3^{rd} level: Two types of object (e.g., globes, miniature cars) are presented at a rate of one object every 2 seconds (time spent in the highlighted box). The participant must select only globes, then the rule is reversed so that the participant must pick up only cars. The rule switch occurs every 30 seconds over a 3 minute interval.

Selective Attention

1st level: Four types of objects (e.g., globes, miniature cars, dolls & boxes) are presented at a rate of one object every 2 seconds (time spent in the highlighted box). The participant must pick up only one object type (e.g., globes) that appears approximately every fifth item. The participant must do this for 5 minutes. Some occasional noise is present in the background (e.g. voices of other plant workers).

2^{nd} level: Six types of objects (e.g., globes, miniature cars, dolls, boxes, glasses, teddy bears) are presented at a rate of one object every 2 seconds (time spent in the highlighted box). The participant must pick up only one object type (e.g., globes) that appears approximately every fifth item. The participant must do this for 5 minutes. More frequent noise is present in the background (e.g., voices of other workers, and sirens) as well as items falling off the conveyor belt (every 20^{th} item falls off).

3^{rd} level: Eight types of objects (e.g., globes, miniature cars, dolls, boxes, glasses, teddy bears, Lego® blocks, and music boxes) are presented at a rate of one object every 2 seconds (time spent in the highlighted box). The participant must pick up only one object type (e.g. globes) that appears approximately every fifth item. The participant must do this for 5 minutes. Frequent noise is present in the background (e.g., voices of other workers, and sirens). In addition, the light flickers and items fall off the conveyor belt (every 10^{th} item falls off).

Divided Attention

1st level: One type of object (e.g., red and blue globes) is presented at a rate of one object every 2 seconds (time spent in the highlighted box). The participant must select defective globes by color (e.g., red). They must press a button (as soon as possible) to activate another belt every time they hear a specific siren (only two types). The participant must do this for 3 minutes.

2^{nd} level: Two types of object (e.g., globes & miniature cars) are presented at a rate of one object every 2 seconds (time spent in the highlighted box). The participant must select defective globes by color (e.g., red). They must press a button to activate another belt every time they hear a specific siren (4 types to differentiate). The participant must do this for 3 minutes but must monitor a clock to know when the shift is over.

3^{rd} level: Two types of object (e.g., globes & miniature cars) are presented at a rate of one object every 2 seconds (time spent in the highlighted box). The participant must select defective globes by color (e.g., red). They must press a button to activate another belt every time they hear a specific siren (4 types to differentiate). The participant must do this for 5 minutes but must monitor a clock to know when the shift is over.

Other variations on these tasks are clearly possible, to measure different neurobehavioral domains within the ALT. Some redundancy is also an important requirement within the VR test battery, to ensure that participants are performing consistently and that their neurobehavioral ability transcends a specific VE. Some brief examples include:

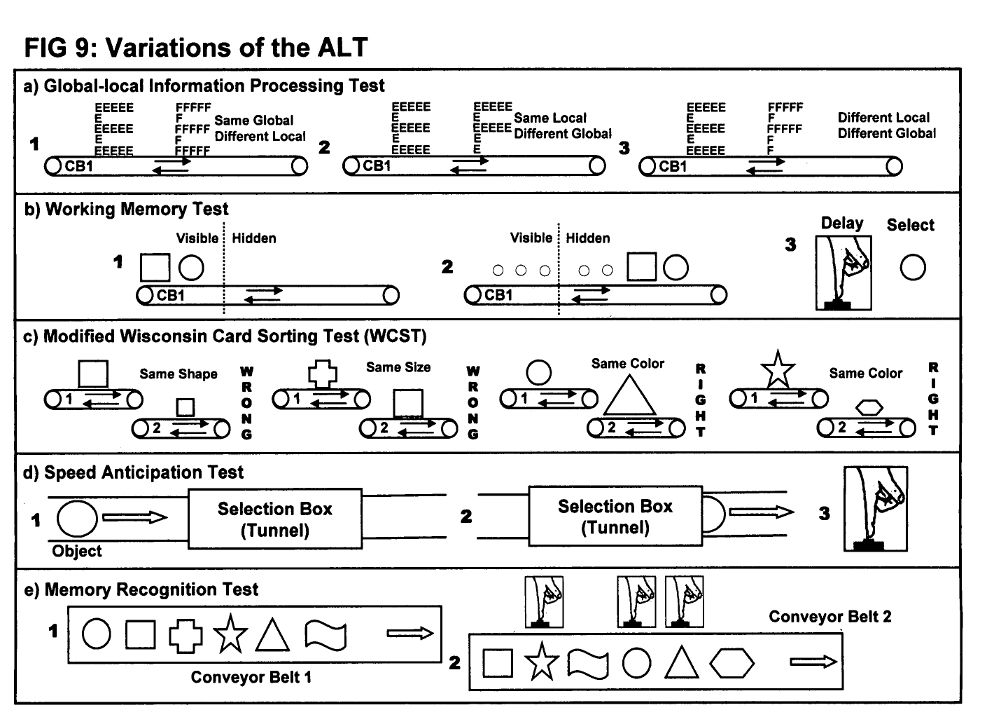

Global-local information processing test. The participant must judge whether objects moving on a single conveyer belt are the same or different based on global detail or local detail. Example objects include big letter pairs filled with smaller letters (FIG. 9A).

Working memory test. The participant must perform an “n-back” condition to select objects that differ in one property (e.g., color, rotation) (FIG. 9B). Operationally, a delay is associated with the button press that selects objects such that the participant must remember the properties of n objects that have already moved out of display. Level of difficulty can be increased by setting the delay for 1-back, 2-back, and 3-back conditions.

Modified WCST. The participant must determine whether objects presented on both conveyer belts are the same or different, based on various object properties (e.g., shape, color, size). In this case, the response mapping of the two buttons changes from object selection to “same” and “different”. Objects are presented slowly on both belts; the participant responds continuous and must change strategy as the matching rule changes, similar to the original WCST (FIG. 9C).

Speed Anticipation Test. To test psychomotor skills, the selection box for a single conveyor belt is made opaque. The participant must judge the time at which an object just begins to disappear and reappear from the selection box. Task difficulty is increased by increasing the speed of the conveyor belt (FIG. 9D).

Memory Recognition Test. The participant observes a sequence of objects moving down one conveyor belt. After the object sequence disappears, a new sequence of objects moves down the other conveyor belt and the participant must select the objects that were part of the original sequence (FIG. 9E).

The preceding embodiments are described in sufficient detail to enable those skilled in the art to practice the present invention. However, it is to be understood that other embodiments may be utilized and that structural, logical, physical, computational, and architectural changes may be made without departing from the spirit and scope of the present invention. The preceding detailed description is, therefore, not to be taken in a limiting sense, and the scope of the present invention is defined only by the appended claims and their equivalents.

1. A method for performing a virtual reality-based test wherein neurobehavioral performance skills can be measured in human subjects, the method comprising,
(a) providing interactive virtual reality-based neurobehavioral tests, wherein a plurality of virtual environments are available to evaluate said neurobehavioral performance skills,
(b) providing an input technology for receiving feedback responses to said interactive virtual reality environment from said human subjects, the neurobehavioral tests automatically self-adjust during operation in accordance with at least one specific purpose of the assessment,
(c) providing an advanced computer workstation which displays said virtual environments to users through various devices, and
(d) recording performance metrics reflecting said neurobehavioral skills of said human subjects.

2. The method of claim 1, wherein said neurobehavioral performance skills include at least one skill selected from the group consisting of motor skills; manual dexterity; praxis; sensory-perceptual skills; sustained, divided and selective attention; executive functioning; planning; decision making; conceptual flexibility; multi-tasking; spontaneity; memory; visual spatial ability; visual constructional ability; visual tracking ability; visual motor ability; mood; personality; intelligence; and pre-morbid ability.

3. The method of claim 1, wherein the neurobehavioral performance skills comprise one or more neurobehavioral abilities that are measured within a single virtual environment.

4. The method of claim 1, wherein said neurobehavioral skills are used as a screening measure within a sole virtual environment to provide an overall measure of general cognitive function or motor function.

5. The method of claim 1, wherein patients with neurologic and psychiatric dysfunctions are also assessed with at least one physiologic monitoring tool selected from the group consisting of monitors for heart rate, blood pressure, respiratory rhythms, EMG, and skin conductance response.

6. The method of claim 1, wherein a) functional magnetic resonance imaging is used to non-invasively map neuroanatomic correlates of virtual reality-based test performance, b) physiological and metabolic monitoring tools are used in conjunction with functional magnetic resonance imaging and normative data or both a) and b) are used.

7. The method of claim 1, wherein said virtual reality-based neurobehavioral testing system is portable, allowing computerized tests to be administered in a desk-top or lap-top configuration.

8. The method of claim 8, wherein said computerized tests are administered and results transmitted via the Internet for tele-assessment of human subjects who are physically inaccessible to a test administrator.

9. The method of claim 1, wherein said neurobehavioral tests are used for vocational assessment or training.

10. The method of claim 10, wherein individual test scores obtained from said neurobehavioral tests are combined into a final metric useful for assessing a candidate's qualifications for employment.

11. The method of claim 1, wherein said neurobehavioral tests are adjusted or tailored to the needs of an individual client and a purpose of the assessment.

12. The method of claim 11, wherein a comprehensive series of virtual reality-based tests is used to index more than one domain of cognitive functioning.

13. The method of claim 12 wherein the domain of cognitive functioning is selected from the group consisting of learning, memory, attention and executive function.

14. The method of claim 12 wherein the domain of cognitive functioning comprises cognitive dysfunction resulting from a condition selected from the group consisting of cranial trauma, Alzheimer's disease, Parkinsonism, frontotemporal dementia, stroke, schizophrenia, vertigo, autism, depression, psychosis, transient global amnesia, memory disabilities, balance disabilities, Tourette's Syndrome, Tinnitis, Multiple Sclerosis and Multiple Sclerosis-like syndrome, hyperactivity, Attention Deficit Disorder, deficits resulting from strokes, migraine, seizures, balance disorders, concussion, post-concussion syndrome, cerebral ischemia, vascular dysfunction, peripheral vascular and vertigo

15. The method of claim 13, wherein said neurobehavioral tests are used as individualized virtual reality paradigms for specific cognitive rehabilitative strategies.

16. The method of claim 13, wherein said neurobehavioral tests integrate learning principles and psychotherapeutic strategies that utilize visual, auditory, and tactile sensory stimulation and feedback during user immersion in virtual environments to assist patients in achieving corrective experiences.

17. The method of claim 16, wherein said neurobehavioral tests also incorporate a functional neuroimaging component, and particularly functional magnetic resonance imaging.

18. The method of claim 17, wherein said functional neuroimaging is correlated to the virtual reality neurobehavioral test to improve the specificity of a clinical diagnosis or to identify an appropriate rehabilitation strategy.

19. The method of claim 10, said neurobehavioral tests include individualized virtual measures for specific vocational and educational needs which may predict future employment/success in the workplace or school.

20. The method of claim 9, wherein the virtual measures are provided over the internet so that brain function is assessed in persons in remote areas or within associated health-care centers in an urban area.

21. The method of claim 1, wherein said virtual reality-based neurobehavioral examination self-adjusts during operation to increase or decrease the difficulty of the test protocol.

22. The method of claim 12, wherein said neurobehavioral tests provide individualized virtual measures which are useful for specific educational needs.

23. The method of claim 23, wherein said individualized virtual measures are useful for predicting future employment/success in the workplace or school.

24. The method of claim 1 wherein the recorded performance metrics are compared to a normative database.
